(19) United States
(12) Patent Application Publication
(10) Pub. No.: US 2019/0080090 A1
(43) Pub. Date: Mar. 14, 2019

(54) METHOD AND APPARATUS FOR DETECTING DYNAMICALLY-LOADED MALWARE WITH RUN TIME PREDICTIVE ANALYSIS

(71) Applicant: QUALCOMM Incorporated, San Diego, CA (US)

(72) Inventors: Dong LI, Cupertino, CA (US); Yin CHEN, Campbell, CA (US); Saumitra Mohan DAS, San Jose, CA (US)

(21) Appl. No.: 15/701,319

(22) Filed: Sep. 11, 2017

(51) Int. Cl. G06F 21/56

(52) U.S. Cl. CPC G06F 21/566; G06F 21/602; G06F 2221/034

(57) ABSTRACT

In an aspect, an apparatus obtains a first payload that is dynamically loaded by an application program of the apparatus. For example, the first payload may be dynamically loaded by an application program (e.g., during run time) for execution on the apparatus. The apparatus determines whether the first payload includes malicious content. The apparatus prevents execution of the first payload when the first payload includes the malicious content, and executes the first payload when the first payload does not include the malicious content.

### INTRODUCTION

### Field of the Disclosure

Aspects of the disclosure relate generally to a method and apparatus for detecting dynamically-loaded malware with run time predictive analysis.

### Background

Application programs (e.g., application programs for a mobile operating system) in a client device may dynamically load payloads at run time. For example, the payloads may include code (e.g., bytecode) and may be downloaded from a server in a network (e.g., the Internet) or obtained from encrypted local files. For example, an application program may initiate such dynamic loading of payloads by calling one or more functions while the application program is running. Such functions may be included in an application programming interface of the client device.

Many types of malware dynamically load payloads to evade static analysis based anti-virus protection. These types of malware may not include harmful code/instructions at installation time (e.g., prior to execution) to avoid being detected by anti-virus software. However, these types of malware may dynamically load payloads including malicious content to damage the client device at run time.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In an aspect of the present disclosure, a method for an apparatus is disclosed. For example, the apparatus may be a client device. The client device obtains a first payload that is dynamically loaded by an application program of the client device, determines whether the first payload includes malicious content, prevents execution of the first payload when the first payload includes the malicious content, and executes the first payload when the first payload does not include the malicious content. In an aspect of the disclosure, the determination as to whether the first payload includes malicious content includes analyzing at least a software code, a library, or a data structure in the first payload to identify the malicious content. In an aspect of the disclosure, at least the determination as to whether the first payload includes malicious content, the preventing execution of the first payload when the first payload includes the malicious content, or the executing the first payload when the first payload does not include the malicious content is controlled by one or more application programming interfaces of the client device.

In an aspect of the disclosure, the client device obtains a function call flow of the application program, the function call flow indicating a second payload that is to be dynamically loaded by the application program, obtains the second payload before the second payload is dynamically loaded by the application program, determines whether the second payload includes the malicious content, prevents dynamic loading of the second payload when the second payload includes the malicious content, and allows the dynamic loading of the second payload when the second payload does not include the malicious content.

In an aspect of the disclosure, the client device analyzes the application program to determine a value of a confidence metric, prevents the application program from dynamically loading a second payload when the value is below a threshold, and allows the application program to dynamically load the second payload when the value is greater than or equal to the threshold. In an aspect of the disclosure, the client device prevents execution of the second payload when the second payload includes the malicious content, and executes the second payload when the second payload does not include the malicious content.

In an aspect of the disclosure, the client device determines whether the application program at the client device includes the malicious content, determines whether the application program in combination with the first payload includes the malicious content, and provides a message indicating whether any of the application program, the first payload, and the application program in combination with the first payload includes the malicious content.

In an aspect of the disclosure, the application program implements an application programming interface of the client device to dynamically load the first payload, wherein the implementation of the application programming interface triggers the determining whether the first payload includes malicious content.

In an aspect of the disclosure, the first payload is excluded from the application program prior to execution of the application program. In an aspect of the disclosure, the first payload includes at least software code that is executable at the client device. In an aspect of the disclosure, the first payload is dynamically loaded from a network or an external device that is in communication with the client device. In an aspect of the disclosure, the first payload includes software code that has been stored in a local memory of the client device in encrypted form and decrypted by the application program at run time. In an aspect of the disclosure, the preventing execution of the first payload when the first payload includes the malicious content includes halting the application program. In an aspect of the disclosure, the client device provides a notification to a user of the client device regarding a result of the determination. In an aspect of the disclosure, the first payload is compiled for execution during the determining whether the first payload includes malicious content.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates a block diagram of an example client device in accordance with the various aspects of the disclosure.

FIG. 2 illustrates an example triggering of one or more security operations of the client device when dynamic loading of a payload is attempted in accordance with the various aspects of the disclosure.

FIG. 3 is a flowchart illustrating an example triggering of one or more security operations of the client device when dynamic loading of a payload is attempted in accordance with the various aspects of the disclosure.

FIG. 4 is a flowchart illustrating an example triggering of one or more security operations of the client device based on a result of an analysis of an application installation package.

FIG. 5 illustrates a flowchart for identifying a configuration of malicious content.

FIG. 6 is a block diagram illustrating select components of an apparatus according to at least one example of the present disclosure.

FIG. 7 is a flowchart illustrating a method in accordance with various aspects of the present disclosure.

FIG. 8 (including FIGS. 8A and 8B) is a flowchart illustrating a method in accordance with various aspects of the present disclosure.

FIG. 9 (including FIGS. 9A and 9B) is a flowchart illustrating a method in accordance with various aspects of the present disclosure.

FIG. 10 is a flowchart illustrating a method in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

This disclosure is directed to the detection of malicious content in dynamically loaded payloads and approaches to protect a client device from dynamically loaded payloads that include malicious content. In one example, an application program running on a client device may dynamically load a payload by calling one or more functions of an application programming interface (API) as follows:

DexClassLoader classloader=new DexClassLoader (Path-to-payload, . . . , . . . ) classloader.loadClass(“com.apkbeloaded.Registry”).

As used herein, the term “payload” may include software, code (e.g., source code, machine code, bytecode), code segments, instructions, functions, libraries, data structures, metadata, and/or other types of information that may be used to initiate or control operations of a computing platform. As used herein, the term “application program” may be used interchangeably with the terms host application, host software, software program, application software, or applications (e.g., “apps”)). For example, an application program may be included in an application installation package file, such as an Android™ application package kit (APK) file, that may be purchased and downloaded to a client device from an online application store (e.g., “appstore”). In such example, the application installation package may be used by the client device to install the application program.

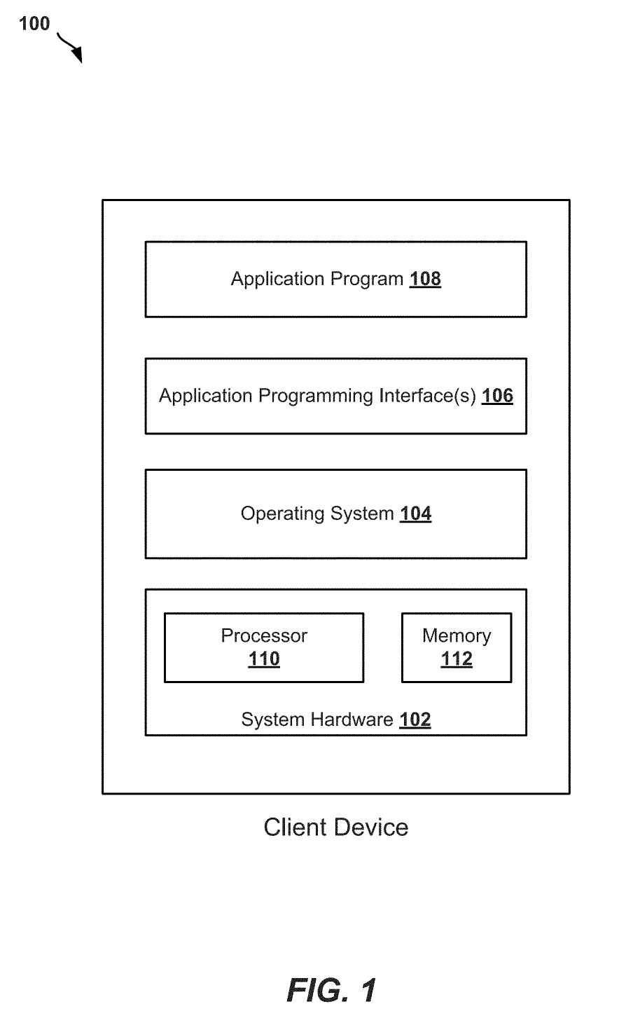

FIG. 1 illustrates a block diagram of an example client device 100 in accordance with the various aspects of the disclosure. For example, the client device 100 may be a cellular telephone (e.g., a smartphone), a user equipment (UE), a personal computer (e.g., a laptop), a tablet device, a gaming device, or any other suitable device that is configured to run one or more application programs. In some aspects, the client device 100 may support wired networking technologies (e.g., Ethernet, Universal Serial Bus (USB)) and/or wireless networking technologies (e.g., Wi-Fi™, Bluetooth™) to access a network (e.g., the Internet or a local area network (LAN)) and/or to pair with other electronic devices (e.g., other client devices, servers, storage devices). In some aspects, the client device 100 may be configured to communicate with a wireless communication network (e.g., Long Term Evolution (LTE) network, 5G, etc.).

As shown in FIG. 1, the client device 100 includes system hardware 102, an operating system 104, one or more application programming interfaces 106, and an application program 108. For example, the system hardware 102 may be a hardware platform on which the operating system 104 and the application program 108 can run. In an aspect of the disclosure, the system hardware 102 may include one or more processors (e.g., processor 110) and one or more memory devices (e.g., memory device 112). The system hardware 102 may include additional components and/or connections, which have been omitted from FIG. 1 for the sake of brevity and ease of illustration. In the aspects described herein, the operating system 104 may be a mobile operating system, such as the Android™ operating system. It should be understood, however, that the aspects described herein may apply to operating systems other than mobile operating systems, such as Windows™ or macOS™.

### Triggering Analysis of Dynamic Payloads

In one aspect of the disclosure, the application program 108 running on the client device 100 may call a function to dynamically obtain and load a payload (also referred to as a dynamic payload) during run time of the application program 108. In one aspect of the disclosure, the function may be included in one of the API(s) 106. In another aspect of the disclosure, the function may itself be one of the APIs 106. An example of a function that may dynamically obtain and load a payload may be the “LoadDexFile( )” function, which may be supported on the Android™ platform.

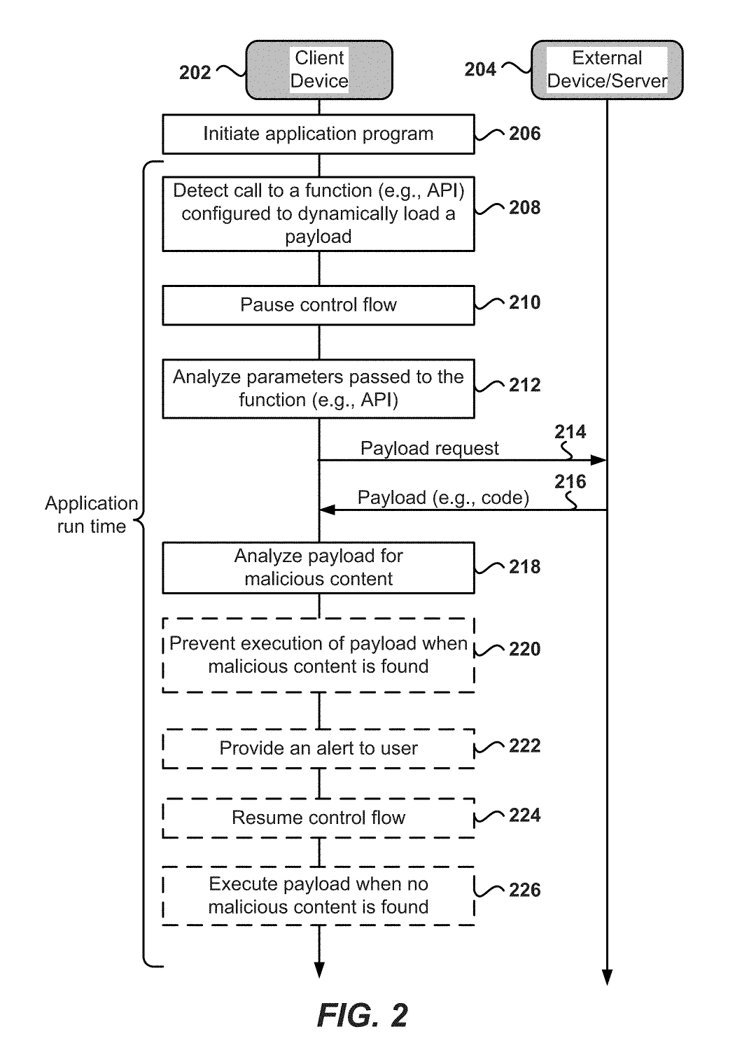

In one aspect of the disclosure, and as described in detail herein, when the client device 100 detects that the application program 108 has called a function (e.g., one of the API(s) 106) to dynamically obtain and load a payload for execution on the client device 100, the calling of such function may trigger the client device 100 to analyze one or more portions of the payload for malicious content. In one aspect of the disclosure, one or more security operations of the client device 100 may be included in the API(s) 106 to protect against unauthorized attempts by the application program 108 to dynamically obtain and load a payload that may include malicious content. For example, the one or more security operations may be triggered when the application program 108 attempts to call a function (e.g., one of the API(s) 106) to dynamically obtain and load a payload for execution on the client device 100. An example implementation of such security operations by the client device 100 is described herein with reference to FIG. 2.

FIG. 2 illustrates an example triggering of one or more security operations (e.g., operations 208 through 226 in FIG. 2) of the client device 202 when dynamic loading of a payload is attempted in accordance with the various aspects of the disclosure. In one aspect, the client device 202 may correspond to the client device 100 in FIG. 1. For example, the client device 202 may be in communication with the external device/server 204 using one of the previously described wired or wireless networking technologies. For example, the external device/server 204 may be an external memory device (e.g., a USB memory drive), a server accessible on the Internet (e.g., an application server), or any other server or device that may store and deliver a payload to the client device 202. It should be understood that the operations indicated in dotted lines in FIG. 2 represent optional operations.

As shown in FIG. 2, the client device 202 may initiate 206 an application program (e.g., the application program 108). The client device 202 may detect 208 that the application program has called a function (e.g., one of the API(s) 106) to dynamically obtain and load a payload for execution on the client device 202. In response to the detection, the client device 202 may pause 210 the control flow of the client device 202 and may analyze 212 the parameters passed to the function. In an aspect of the disclosure, pausing the control flow suspends the called function to allow time for analysis of the parameters passed to the function. For example, the parameters passed to the function to dynamically obtain and load a payload may indicate a memory region (e.g., one or more memory addresses), a pointer, a uniform resource identifier (UOI), a filename, a file path, and/or a Web uniform resource locator (URL). In an aspect, when the parameters indicate one or more memory regions, the client device 202 may be configured to dump the one or more memory regions to search for any malicious content that may be stored in the one or more memory regions. In an aspect, analysis of the previously described parameters passed to the function may involve determining whether the parameters include any executable code and/or whether the parameters include a pointer indicating where executable code may be obtained.

The client device 202 may send a payload request 214 to the external device/server 204 and may obtain the payload 216. The client device 202 may analyze (e.g., using a predictive analysis approach, which may also be referred to as a machine learning based static analysis) the obtained payload for malicious content 218. For example, and in accordance with the aspects described herein, analysis of a payload (and/or an application installation package) for malicious content may involve a determination of one or more APIs implemented by the payload, and comparing the one or more APIs to a library of APIs that are known or likely to be harmful or damaging. For example, APIs that are to be implemented by a payload may be listed in the bytecode included in the payload. In some aspects of the disclosure, the client device 202 may perform statistical analysis to determine whether the one or more APIs implemented by the payload are likely to cause damage to the client device 202. Accordingly, a determination that the one or more APIs implemented by the payload are likely to cause damage to the client device 202 may enable the client device 202 to conclude that the payload contains malicious content. As another example, and in accordance with the aspects described herein, analysis of a payload (and/or an application installation package) for malicious content may involve a determination of the information (e.g., hardcoded URLs, embedded strings) included in the payload, and matching such information to a database that includes information known or likely to be harmful or damaging to the client device 202. For example, the database may include, among other items of information, a list of URLs that are known to be associated with malicious activity. In other aspects, if one or more APIs implemented by a payload appear suspicious or unfamiliar to the client device 202, the client device 202 may conclude that such APIs are malicious.

In the event that the analysis finds malicious content in the obtained payload, the client device 202 may prevent execution 220 of the payload. In an aspect of the disclosure, the client device 202 may provide 222 an alert to the user of the client device 202 that malicious content has been found. In some aspects of the disclosure, the client device 202 may alert other application programs that may be currently running on the client device 202 that a payload including malicious content has been detected. Such an alert may allow the other applications to take protective measure, such as disabling certain features, logging out or ending a session, and/or quitting the application. When the analysis does not find malicious content in the obtained payload, the client device 202 may resume 224 the control flow and the client device 202 may proceed to load and execute 226 the payload.

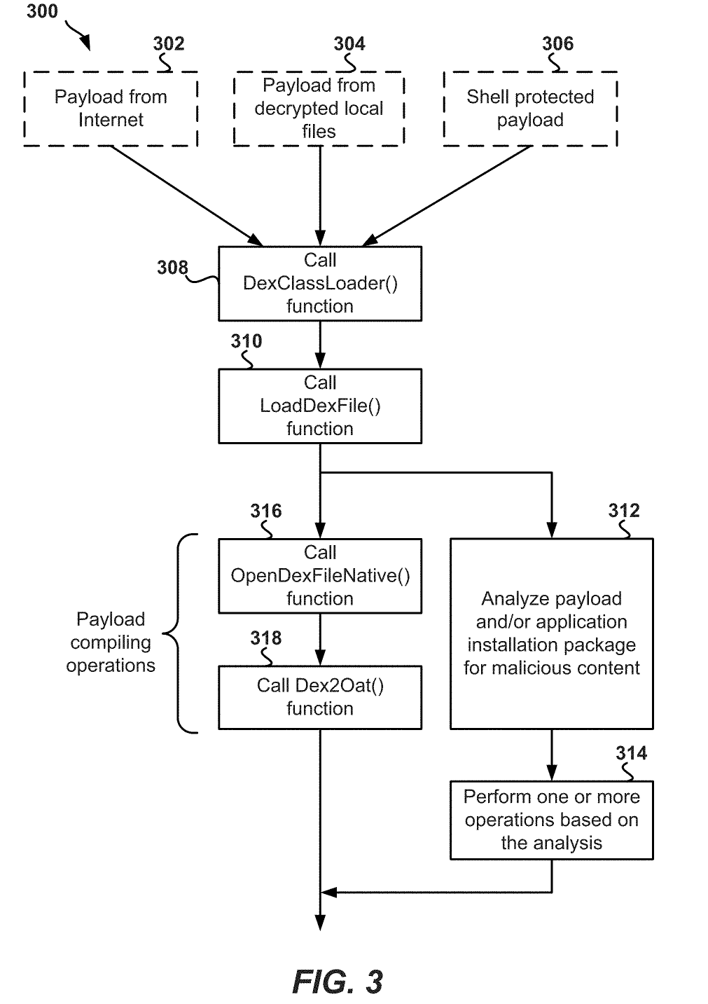

FIG. 3 is a flowchart 300 illustrating an example triggering of one or more security operations of the client device 100 when dynamic loading of a payload is attempted in accordance with the various aspects of the disclosure. It should be understood that the elements in FIG. 3 indicated with dotted lines represent optional elements.

As shown in FIG. 3, the application program 108 of the client device 100 may call the DexClassLoader( ) function 308. In one example, the DexClassLoader( ) function may download a payload 302 from the Internet. In another example, the DexClassLoader( ) function may obtain a payload 304 by decrypting one or more encrypted files stored in a local memory (e.g., the memory 112). In this example, the one or more encrypted files may be included in an application installation package file, such as an APK file, stored in the memory 112. In another example, the DexClassLoader( ) function may obtain a shell protected payload 306. The application program 108 may then call the LoadDexFile( ) function 310 to load the payload (e.g., the code included in the payload) into memory. For example, the LoadDexFile( ) function may mark the payload as executable code and may request a virtual machine (e.g., a Java™ virtual machine) to load the payload for execution by the processor 110. In this example, the payload (e.g., the payload 302, 304, 306) may include code that is in Java™ bytecode form. As shown in FIG. 3, the application program 108 may compile the payload by calling the OpenDexFileNative( ) function 316 and by calling the Dex2Oat( ) function 318. The Dex2Oat( ) function may compile the payload “ahead of time” (also abbreviated as “OAT”). For example, the Dex2Oat( ) function may be configured to take a dex file (e.g., a Dalvik Executable file) and convert it to native code that can be understood and executed by the processor 110 without the need for a virtual machine.

In an aspect of the disclosure, upon loading the obtained payload into memory (e.g., after the LoadDexFile( ) function is called), one or more security operations (e.g., operations 312, 314 in FIG. 3) of the client device 100 may be triggered. Accordingly, the client device 100 may pause the control flow and may analyze (e.g., using a predictive analysis operation) the loaded payload (also referred to as the dynamically loaded payload) and/or the application installation package for malicious content 312. In some aspects of the disclosure, a query function may be included in the Dex2OAT( ) function to prevent the dynamically loaded payload from executing until the result of the analysis (e.g., at operations 312, 314 in FIG. 3) is obtained. In some aspects of the disclosure, operation 312 may be performed in parallel (e.g., concurrently) with operations 316 and 318. In such aspect, the client device 100 may implement a first set of cores in the processor 110 to perform operations 316 and 318, and may implement a second set of cores in the processor 110 to implement operation 312.

The client device 100 may perform one or more operations based on the analysis 314. In one aspect, the one or more operations may include halting the application program 108 when the analysis finds malicious content in the loaded payload and/or the application installation package. In another aspect, the one or more operations may include allowing the application program 108 to resume when the analysis does not find malicious content in the loaded payload and/or the application installation package. In some aspects of the disclosure, the one or more operations may include providing a notification to the user of the client device 100 regarding the results of the analysis (e.g., to notify the user that malicious content has been found).

In one aspect of the disclosure, the one or more security operations (e.g., operations 312, 314) of the client device 100 described with respect to FIG. 3 may be implemented in one or more of the APIs 106 used by the application program 108. In some aspects of the disclosure, the analysis for detecting malicious content may be implemented by a dedicated analysis module (e.g., software or an apparatus, such as a circuit), which may be configured to analyze dynamically loaded payloads and determine whether or not such dynamically loaded payloads are malicious. The analysis module may employ one or more techniques to check the obtained dynamically loaded payloads for malicious content. It should be noted that the aspects described with reference to FIG. 3 include functions supported by the Android™ platform. However, those skilled in the art will appreciate that the described triggering of the one or more security operations of the client device 100 may be similarly implemented on other platforms that call functions (e.g., API(s)) similar to those described with reference to FIG. 3.

### Triggering Analysis Prior to Dynamic Loading of Payloads

Triggering of the previously described security operations when the client device 100 detects execution of a function (e.g., one of the API(s) 106) for dynamically loading a payload as described with reference to FIGS. 2 and 3 may briefly delay the launch or use of the associated application program 108. Such delays may be avoided in situations where the client device 100 is able to anticipate an attempt by the application program 108 to dynamically load a payload. Accordingly, in some aspects of the disclosure, one or more of the previously described security operations of the client device 100 may be triggered before the application program 108 calls a function for dynamic loading of a payload and/or before any actual dynamic loading of a payload begins. For example, the client device 100 may implement a call graph screening operation that analyzes the call graphs of the application program 108 (e.g., upon installation of the software application 108 and/or prior to the launch of the application program 108) to determine the origins of control flows (also referred to as function call flows) that will attempt to dynamically load a payload. In an aspect of the disclosure, the one or more security operations of the client device 100 may be triggered when the call graph screening operation detects a function that may attempt to dynamically load a payload. In another aspect of the disclosure, the one or more security operations of the client device 100 may be triggered when a function for obtaining a dynamic payload returns with the dynamic payload (e.g., prior to loading of the dynamic payload in memory for execution by the processor 110).

In one example, the application program 108 may be configured to implement the following function call flow: registerClient( )→getNewPayload( )→downloadNewCode( )→downloadOtherUpdates( )→prepareEnvironmentVars( )→loadDexFile( ). In this example, the call graph screening operation of the client device 100 may analyze the function call flow to determine whether the function call flow will lead to the dynamic loading of a payload. For example, this analysis may be performed before the application program 108 attempts to dynamically load a payload. In an aspect of the disclosure, the call graph screening operation may identify a function in the function call flow that may attempt to dynamically obtain a payload, such as the downloadNewCode( ) function, and may identify a function in the function call flow that may attempt to dynamically load the obtained payload, such as the loadDexFile( ) function. In such aspect, the one or more security operations (e.g., pausing the control flow and analyzing the obtained dynamic payload for malicious content) of the client device 100 may be triggered as early as when the function downloadNewCode( ) returns with a dynamic payload. Accordingly, the client device 100 may analyze the dynamic payload for malicious content in a manner previously described with reference to FIG. 2 or FIG. 3 before the dynamic payload is loaded in memory for execution by the processor 110. In some scenarios, the client device 100 may complete the analysis of the dynamic payload even before the function loadDexFile( ) is called in the example function call flow. Therefore, by triggering the security operations of the client device 100 before the application program 108 attempts to load any dynamic payloads, benign application programs (e.g., safe or trusted application programs) that are configured to dynamically load payloads may not experience the previously described delays.

### Triggering Security Operations Based on an Analysis of an Application Installation Package

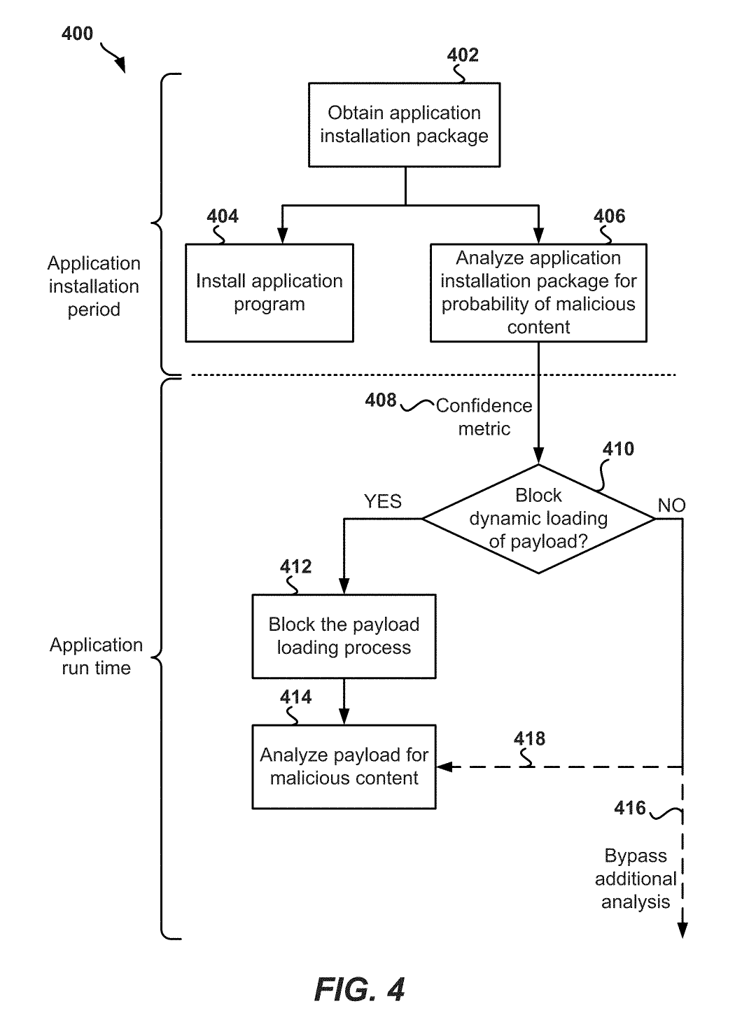

In one aspect of the disclosure, one or more of the previously described security operations of the client device 100 may be triggered based on a result of an analysis of an application installation package (e.g., host APK). FIG. 4 is a flowchart 400 illustrating an example triggering of one or more security operations of the client device 100 based on a result of an analysis of an application installation package. As shown in FIG. 4, the client device 100 may obtain an application installation package (e.g., a host APK) 402. For example, the client device 100 may download the application installation package from a server (e.g., on the Internet) or may transfer the application installation package to the client device from an external storage device. The client device 100 may execute the application installation package in order to install the associated application program (e.g., the application program 108) 404. As shown in FIG. 4, the client device 100 may analyze the application installation package to determine the probability of the application installation package including malicious content 406. In one aspect of the disclosure, the client device 100 may analyze the application installation package by accessing (e.g., from an external server/device, or a database in the memory 112) a list of trusted applications (e.g., applications from reputable/known software developers, such as Microsoft™, Google™, etc.). If the application installation package matches one of the trusted applications in the list, the client device 100 may allow the application program (e.g., the application program 108) associated with the application installation package to execute at run time. Otherwise, if the application installation package is not included in the list, the client device 100 may analyze the application installation package for malicious content. In one aspect, the result of the analysis may be a value of a confidence metric 408 (also referred to as a confidence score or a safety level value) that estimates the safety level of the application installation package. For example, the value of the confidence metric may be a number within the range of 0 to 100, where 100 indicates that the application installation package is completely benign and where 0 indicates that the application installation package is not benign (e.g., high risk, malicious).

When the application program (e.g., the application program 108) is executed (e.g., during the application run time below the dotted line in FIG. 4), the application program may call a function (e.g., one of the API(s) 106) to dynamically load a payload for execution on the client device 100. As shown in FIG. 4, the client device 100 may determine whether to block the dynamic loading of the payload 410. In one aspect, the client device 100 may determine whether to block the dynamic loading of the payload based on the value of the confidence metric 408. For example, if the value of the confidence metric 408 is below a threshold value, the client device 100 may determine to block the loading process 412 and may proceed to analyze the payload for malicious content 414. Otherwise, if the value of the confidence metric 408 is greater than or equal to the threshold value, the client device 100 may determine to not block the loading process 412 and may optionally bypass additional analysis of the payload 416. In one aspect of the disclosure, if the value of the confidence metric 408 is greater than or equal to threshold value, the client device 100 may determine to not block the loading process 412 (e.g., the client device 100 may allow the payload to be loaded in memory for execution), but may optionally analyze the payload for malicious content as indicated with the arrow 418 in FIG. 4. In this aspect, the client device 100 may prevent execution of the loaded payload that includes malicious content.

Therefore, in accordance with the aspect described with reference to FIG. 4, if a host APK is determined to be safe with a high level of confidence, the dynamic loading of a payload may be allowed to proceed (e.g., not blocked) and the application program may execute without delays. In some aspects of the disclosure, a copy of any dynamically loaded payload may be obtained and the client device 100 may analyze the payload for malicious content. Therefore, even if a dynamically loaded payload behaves maliciously, the approach described with reference to FIG. 4 enables detection of the (malicious) host APK to prevent (e.g., block) future dynamic loading of payloads.

### Aggregating Analyses for Malicious Content

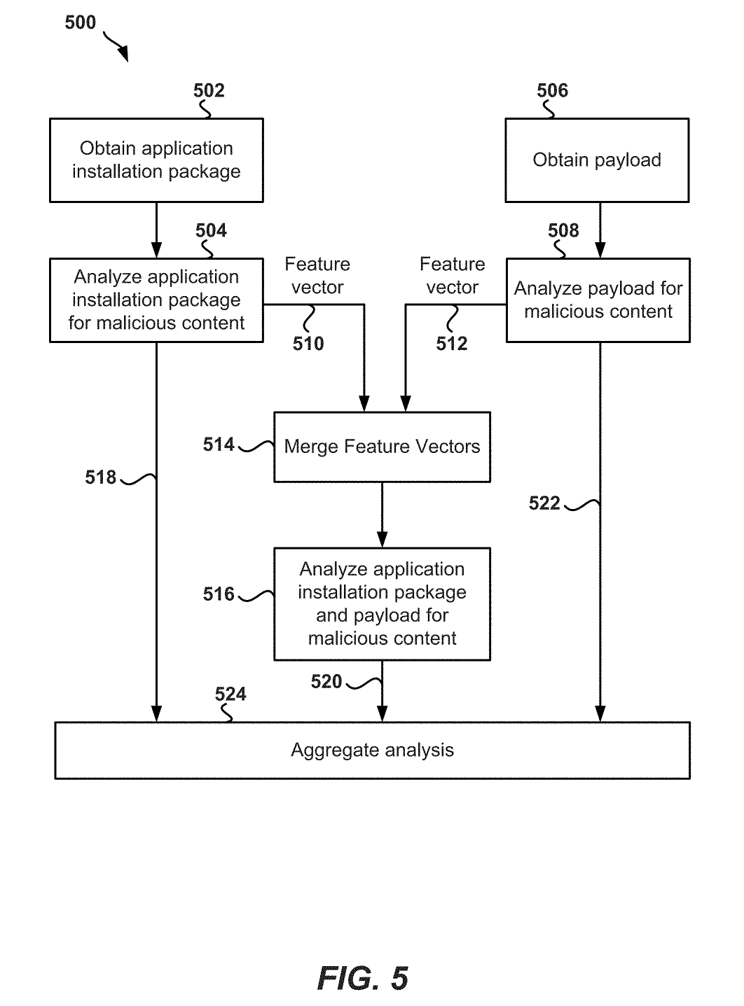

In some aspects of the disclosure, malicious content may exist in one of three configurations: 1) the malicious content may be included only in the application program (e.g., only the host application program is malicious); 2) the malicious content may be included only in the payload (e.g., only the payload is malicious); or 3) the malicious content may be included in the combination of the application program and the payload (this configuration is also referred to as collaborative malware). FIG. 5 illustrates a flowchart for identifying malicious content existing in any one of these configurations.

As shown in the flowchart of FIG. 5, the client device 100 may obtain an application installation package (e.g., a host APK) 502. The client device 100 may analyze the application installation package (or the application program installed at the client device 100 using the application installation package) for malicious content. The client device 100 may further obtain a payload 506. The client device 100 may analyze the payload for malicious content 508. The client device 500 may merge a feature vector 510 resulting from the analysis of the application installation package and a feature vector 512 resulting from the analysis of the payload 514. The client device 500 may analyze the application installation package and the payload for malicious content 516. The client device 100 may then aggregate the result 518 of the analysis of the application installation package, the result 520 of the analysis of the application installation package and the payload, and/or the result 522 of the analysis of the payload 524. In an aspect of the disclosure, the results 518, 520, and 522 may be aggregated to provide a message (e.g., a report or notification) to the user of the client device 100. For example, if the application installation package is determined to be benign, but the dynamically loaded payload is determined to include malicious content, the message may read: “A benign application is loading malicious code.” The message may further provide a warning to the user that may read as follows: “Your server, access point, and/or network is compromised.”

Therefore, it can appreciated that the features disclosed herein may enable detection and/or prevention of dynamic loading of payloads containing malicious content. Moreover, the features disclosed herein may also help to prevent the execution of such payloads containing malicious content. Since such payloads containing malicious content are obtained and loaded dynamically at run time of an application program, the conventional techniques typically implemented by security vendors (e.g., antivirus software developers) may not be able to detect and/or prevent the dynamic loading (or execution) of such payloads containing malicious content.

### Exemplary Device and Method

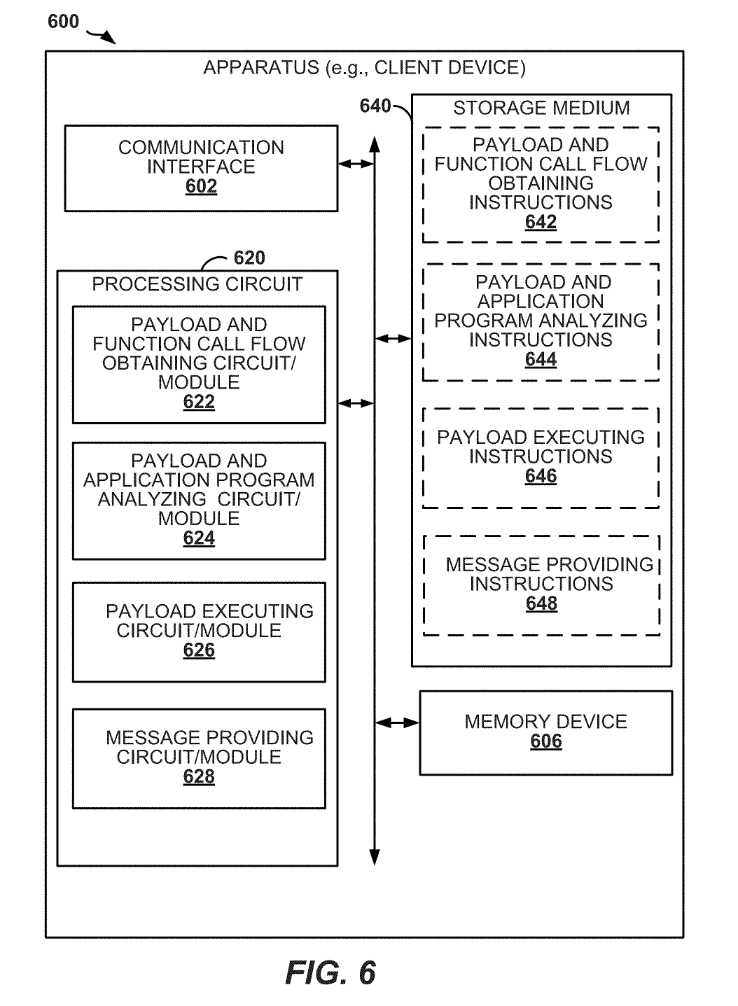

FIG. 6 is block diagram illustrating select components of an apparatus 600 in accordance with various aspects of the disclosure. In some aspects, the apparatus 600 may be a client device, such as the client device 100, 202 as previously described. The apparatus 600 includes a communication interface 602, a memory device 606, a processing circuit 620, and a storage medium 640. The processing circuit 620 is coupled to or placed in electrical communication with each of the communication interface 602, the memory device 606, and the storage medium 640. The communication interface 602 may include, for example, circuitry to support wired or wireless communications (e.g., Wi-Fi®, Bluetooth®, LTE, 5G, etc.). In an aspect, the communication interface 602 may include one or more of: signal driver circuits, signal receiver circuits, amplifiers, signal filters, signal buffers, or other circuitry used to interface with a signaling bus or other types of signaling media.

The processing circuit 620 is arranged to obtain, process and/or send data, control data access and storage, issue commands, and control other desired operations. The processing circuit 620 may include circuitry adapted to implement desired programming provided by appropriate media in at least one example. In some instances, the processing circuit 620 may include circuitry adapted to perform a desired function, with or without implementing programming. By way of example, the processing circuit 620 may be implemented as one or more processors, one or more controllers, and/or other structure configured to execute executable programming and/or perform a desired function. Examples of the processing circuit 620 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 620 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 620 are for illustration and other suitable configurations within the scope of the disclosure are also contemplated.

The processing circuit 620 is adapted for processing, including the execution of programming, which may be stored on the storage medium 640. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 620 may include one or more of: a payload and function call flow obtaining circuit/module 622, a payload and application program analyzing circuit/module 624, a payload executing circuit/module 626, and a message providing circuit/module 628.

The payload and function call flow obtaining circuit/module 622 may include circuitry and/or instructions (e.g., the payload and function call flow obtaining instructions 642 stored on the storage medium 640) adapted to obtain, at a client device, a first payload that is dynamically loaded by an application program of the client device, obtain the second payload before the second payload is dynamically loaded by the application program, and/or obtain a function call flow of the application program, the function call flow indicating a second payload that is to be dynamically loaded by the application program.

The payload and application program analyzing circuit/module 624 may include circuitry and/or instructions (e.g., the payload and application program analyzing instructions 644 stored on the storage medium 640) adapted to determine whether the first payload includes malicious, content, determine whether the second payload includes the malicious content, analyze the application program to determine a value of a confidence metric, determine whether the application program at a client device includes the malicious content, and/or determine whether the application program in combination with the first payload includes the malicious content.

The payload executing circuit/module 626 may include circuitry and/or instructions (e.g., the payload executing instructions 646 stored on the storage medium 640) adapted to prevent execution of the first payload when the first payload includes the malicious content, execute the first payload when the first payload does not include the malicious content, prevent dynamic loading of the second payload when the second payload includes the malicious content, allow the dynamic loading of the second payload when the second payload does not include the malicious content, prevent the application program from dynamically loading a second payload when the value is below a threshold, allow the application program to dynamically load the second payload when the value is greater than or equal to the threshold, prevent execution of the second payload when the second payload includes the malicious content, and/or execute the second payload when the second payload does not include the malicious content.

The message providing circuit/module 628 may include circuitry and/or instructions (e.g., the message providing instructions 648 stored on the storage medium 640) adapted to provide a notification to a user of the client device and/or provide a message indicating whether any of the application program, the first payload, and the application program in combination with the first payload includes the malicious content.

The storage medium 640 may represent one or more processor-readable devices for storing programming, electronic data, databases, or other digital information. The storage medium 640 may also be used for storing data that is manipulated by the processing circuit 620 when executing programming. The storage medium 640 may be any available media that can be accessed by the processing circuit 620, including portable or fixed storage devices, optical storage devices, and various other mediums capable of storing, containing and/or carrying programming. By way of example and not limitation, the storage medium 640 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 640 may be coupled to the processing circuit 620 such that the processing circuit 620 can read information from, and write information to, the storage medium 640. That is, the storage medium 640 can be coupled to the processing circuit 620 so that the storage medium 640 is at least accessible by the processing circuit 620, including examples where the storage medium 640 is integral to the processing circuit 620 and/or examples where the storage medium 640 is separate from the processing circuit 620.

Programming/instructions stored by the storage medium 640, when executed by the processing circuit 620, causes the processing circuit 620 to perform one or more of the various functions and/or process steps described herein. For example, the storage medium 640 may include one or more of: the payload and function call flow obtaining instructions 642, the payload and application program analyzing instructions 644, the payload executing instructions 646, the message providing instructions 648. Thus, according to one or more aspects of the disclosure, the processing circuit 620 is adapted to perform (in conjunction with the storage medium 640) any or all of the processes, functions, steps and/or routines for any or all of the apparatuses described herein. As used herein, the term “adapted” in relation to the processing circuit 620 may refer to the processing circuit 620 being one or more of configured, employed, implemented, and/or programmed (in conjunction with the storage medium 640) to perform a particular process, function, step and/or routine according to various features described herein.

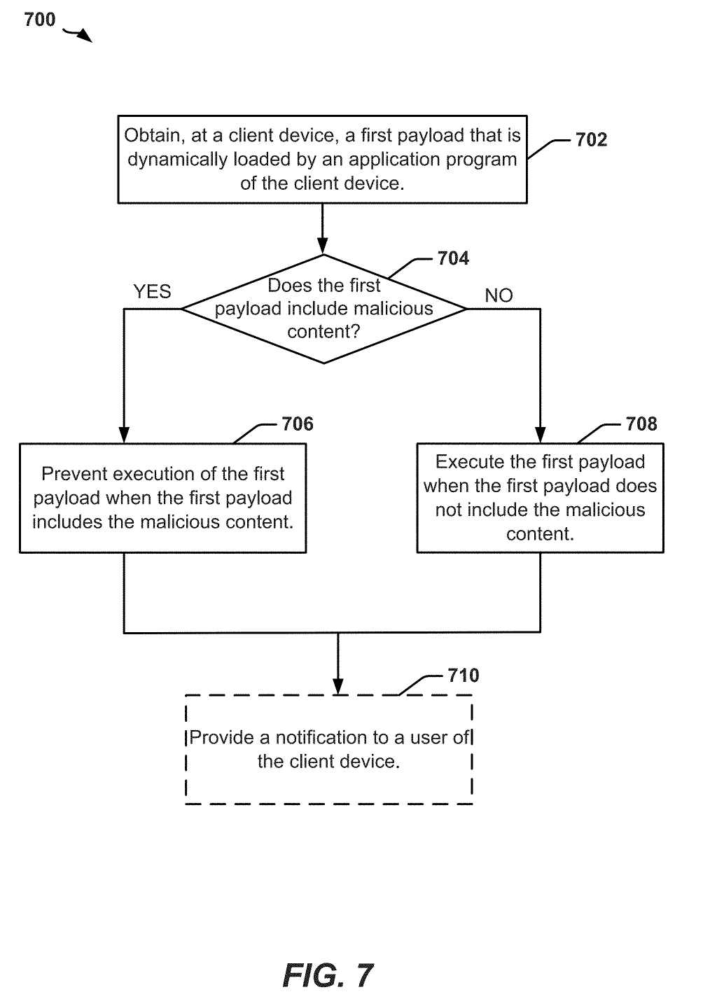

With the above in mind, examples of operations according to the disclosed aspects will be described in more detail in conjunction with the flowchart of FIGS. 7-10.

For convenience, the operations of FIGS. 7-10 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 7 is a flowchart 700 illustrating a method for an apparatus. It should be understood that the operations indicated in dotted lines in FIG. 7 represent optional operations. For example, the apparatus may be a client device (e.g., client device 100, 202). The client device obtains a first payload that is dynamically loaded by an application program of the client device 702. The client device determines whether the first payload includes malicious content 704. The client device prevents execution of the first payload when the first payload includes the malicious content 706. The client device executes the first payload when the first payload does not include the malicious content 708. The client device optionally provides a notification to a user of the client device 710. For example, the notification may indicate to the user that the first payload includes the malicious content or that the first payload does not include the malicious content.

In an aspect of the disclosure, the client device determines whether the first payload includes malicious content by analyzing at least a software code, a library, or a data structure in the first payload to identify the malicious content. In an aspect of the disclosure, the application program implements an application programming interface of the client device to dynamically load the first payload, wherein the implementation of the application programming interface triggers the determining whether the first payload includes malicious content. In an aspect of the disclosure, at least the determining whether the first payload includes malicious content, the preventing execution of the first payload when the first payload includes the malicious content, or the executing the first payload when the first payload does not include the malicious content is controlled by one or more application programming interfaces of the client device. In an aspect of the disclosure, the first payload is excluded from the application program prior to execution of the application program. In an aspect, the first payload includes at least software code that is executable at the client device. In an aspect of the disclosure, the first payload is dynamically loaded from a network or an external device that is in communication with the client device. In an aspect of the disclosure, the first payload includes software code that has been stored in a local memory of the client device in encrypted form and decrypted by the application program at run time. In an aspect of the disclosure, the preventing execution of the first payload when the first payload includes the malicious content includes halting the application program. In an aspect of the disclosure, the first payload is compiled for execution during the determining whether the first payload includes malicious content.

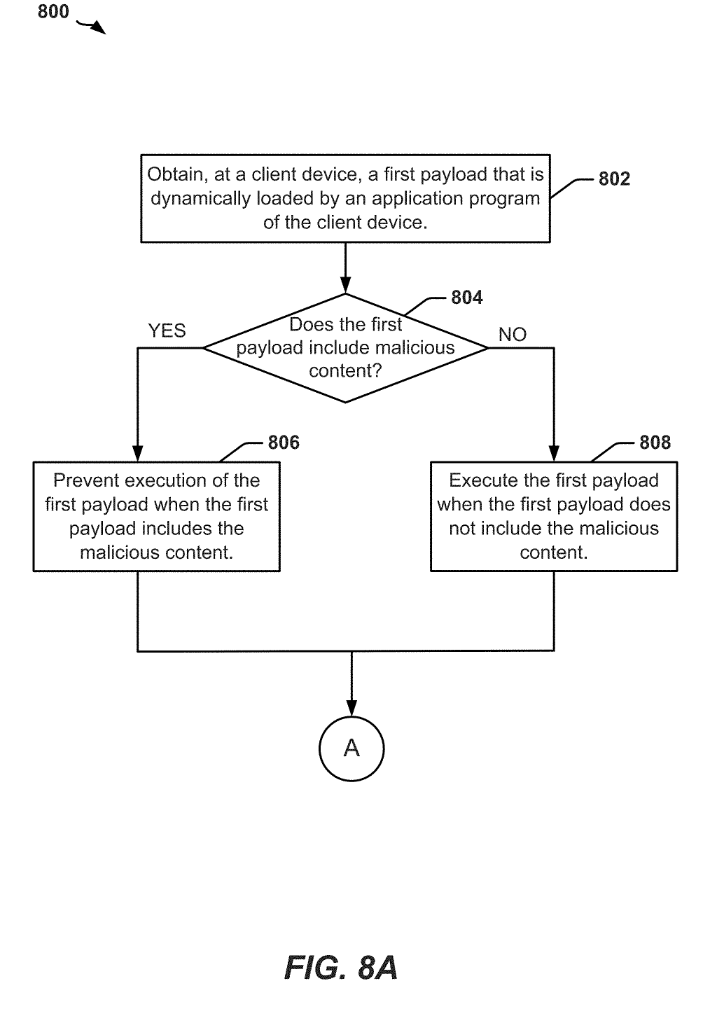

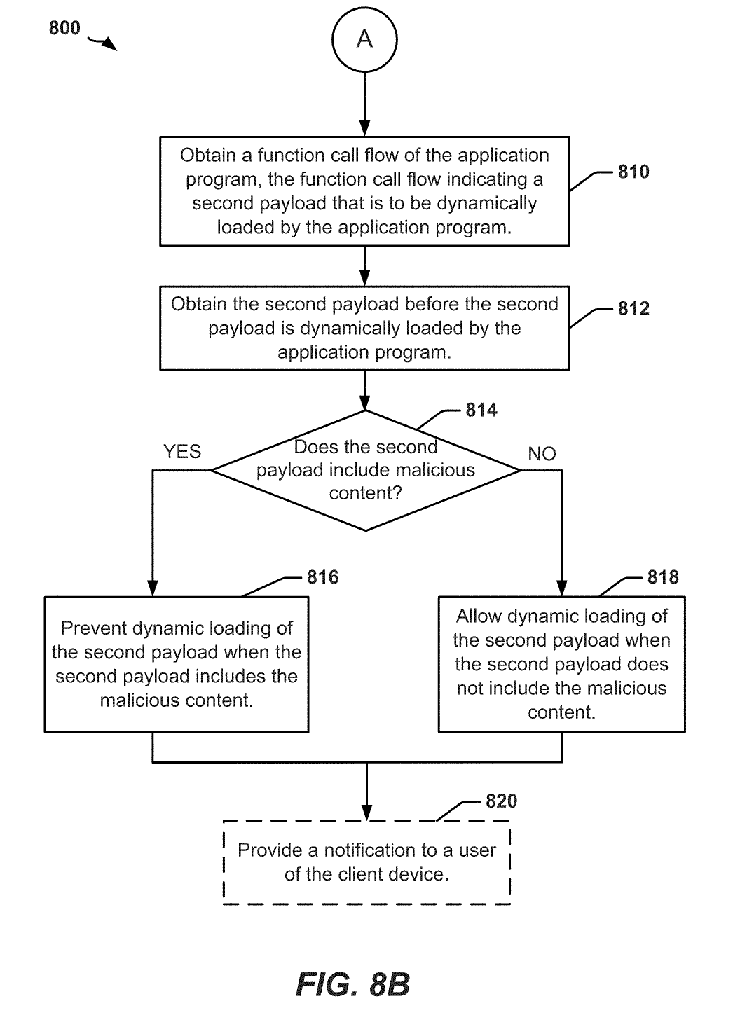

FIG. 8 (including FIGS. 8A and 8B) is a flowchart 800 illustrating a method for an apparatus. It should be understood that the operations indicated in dotted lines in FIG. 8 represent optional operations. For example, the apparatus may be a client device (e.g., client device 100, 202). The client device obtains a first payload that is dynamically loaded by an application program of the client device 802. The client device determines whether the first payload includes malicious content 804. The client device prevents execution of the first payload when the first payload includes the malicious content 806. The client device executes the first payload when the first payload does not include the malicious content 808. With reference to FIG. 8B, the client device obtains a function call flow of the application program, the function call flow indicating a second payload that is to be dynamically loaded by the application program 810. The client device obtains the second payload before the second payload is dynamically loaded by the application program 812. The client device determines whether the second payload includes the malicious content 814. The client device prevents dynamic loading of the second payload when the second payload includes the malicious content 816. The client device allows the dynamic loading of the second payload when the second payload does not include the malicious content 818. The client device optionally provides a notification to a user of the client device 820. For example, the notification may indicate to the user that the second payload includes the malicious content or that the second payload does not include the malicious content.

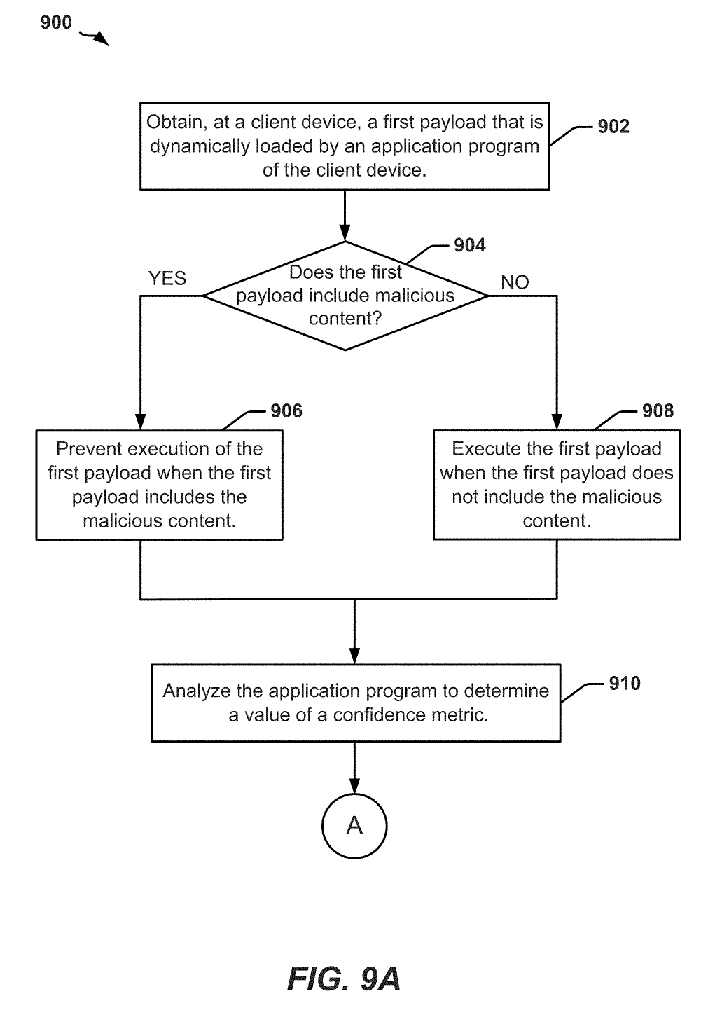

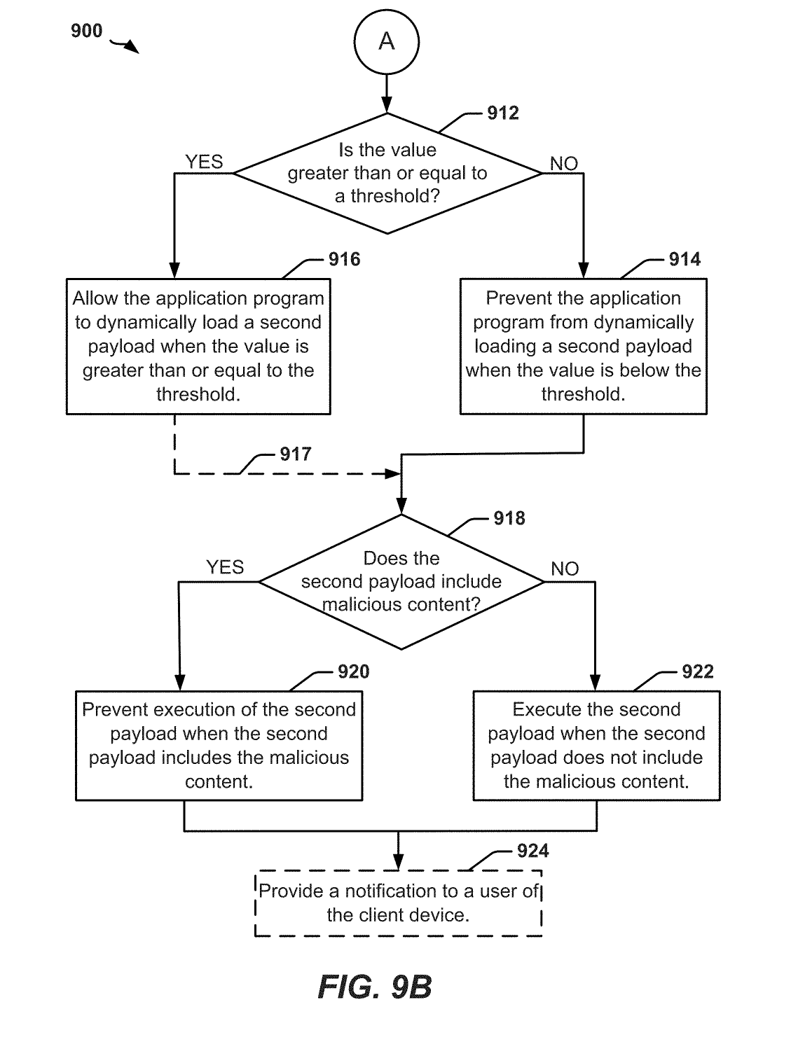

FIG. 9 (including FIGS. 9A and 9B) is a flowchart 900 illustrating a method for an apparatus. It should be understood that the operations indicated in dotted lines in FIG. 9 represent optional operations. For example, the apparatus may be a client device (e.g., client device 100, 202). The client device obtains a first payload that is dynamically loaded by an application program of the client device 902. The client device determines whether the first payload includes malicious content 904. The client device prevents execution of the first payload when the first payload includes the malicious content 906. The client device executes the first payload when the first payload does not include the malicious content 908. The client device analyzes the application program to determine a value of a confidence metric 910. With reference to FIG. 9B, the client device determines whether the value of the confidence metric is greater than or equal to a threshold 912. The client device prevents the application program from dynamically loading a second payload when the value is below the threshold 914. The client device allows the application program to dynamically load the second payload when the value is greater than or equal to the threshold 916. In some aspects of the disclosure, the client device may optionally proceed from operation 916 to the determination operation 918 as indicated with the dotted line 917. The client device determines whether the second payload includes the malicious content 918. The client device prevents execution of the second payload when the second payload includes the malicious content 920. The client device executes the second payload when the second payload does not include the malicious content 922. The client device optionally provides a notification to a user of the client device 924. For example, the notification may indicate to the user that the first payload and/or the second payload includes the malicious content, or that the first payload and/or the second payload does not include the malicious content.

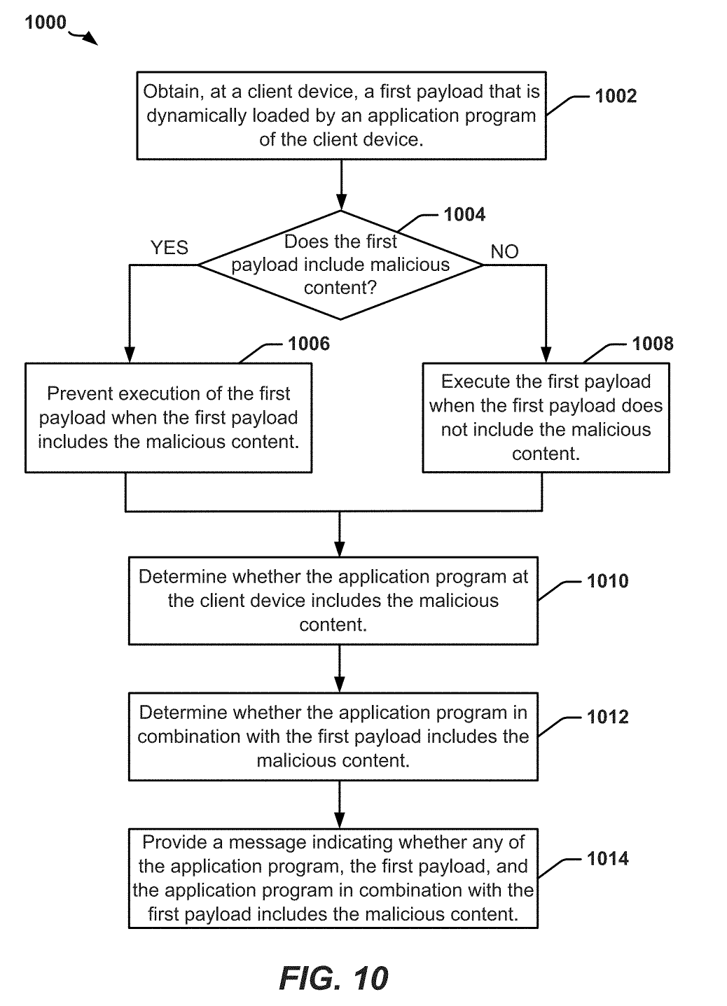

FIG. 10 is a flowchart 1000 illustrating a method for an apparatus. For example, the apparatus may be a client device (e.g., client device 100, 202). The client device obtains a first payload that is dynamically loaded by an application program of the client device 1002. The client device determines whether the first payload includes malicious content 1004. The client device prevents execution of the first payload when the first payload includes the malicious content 1006. The client device executes the first payload when the first payload does not include the malicious content 1008. The client device determines whether the application program at the client device includes the malicious content 1010. The client device determines whether the application program in combination with the first payload includes the malicious content 1012. The client device provides a message indicating whether any of the application program, the first payload, and the application program in combination with the first payload includes the malicious content 1014.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. As used herein, the term “obtaining” may include one or more actions including, but not limited to, receiving, generating, determining, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method, comprising:
obtaining, at a client device, a first payload that is dynamically loaded by an application program of the client device;
determining whether the first payload includes malicious content;
preventing execution of the first payload when the first payload includes the malicious content; and
executing the first payload when the first payload does not include the malicious content.

2. The method of claim 1, further comprising:
obtaining a function call flow of the application program, the function call flow indicating a second payload that is to be dynamically loaded by the application program;
obtaining the second payload before the second payload is dynamically loaded by the application program;
determining whether the second payload includes the malicious content;
preventing dynamic loading of the second payload when the second payload includes the malicious content; and
allowing the dynamic loading of the second payload when the second payload does not include the malicious content.

3. The method of claim 1, further comprising:
analyzing the application program to determine a value of a confidence metric;
preventing the application program from dynamically loading a second payload when the value is below a threshold; and
allowing the application program to dynamically load the second payload when the value is greater than or equal to the threshold.

4. The method of claim 3, further comprising:
preventing execution of the second payload when the second payload includes the malicious content; and
executing the second payload when the second payload does not include the malicious content.

5. The method of claim 1, further comprising:
determining whether the application program at the client device includes the malicious content;
determining whether the application program in combination with the first payload includes the malicious content; and
providing a message indicating whether any of the application program, the first payload, and the application program in combination with the first payload includes the malicious content.

6. The method of claim 1, wherein the determining whether the first payload includes malicious content includes analyzing at least a software code, a library, or a data structure in the first payload to identify the malicious content.

7. The method of claim 1, wherein the application program implements an application programming interface of the client device to dynamically load the first payload, wherein the implementation of the application programming interface triggers the determining whether the first payload includes malicious content.

8. The method of claim 1, wherein at least the determining whether the first payload includes malicious content, the preventing execution of the first payload when the first payload includes the malicious content, or the executing the first payload when the first payload does not include the malicious content is controlled by one or more application programming interfaces of the client device.

9. The method of claim 1, wherein the first payload is excluded from the application program prior to execution of the application program.

10. The method of claim 1, wherein the first payload includes at least software code that is executable at the client device.

11. The method of claim 1, wherein the first payload is dynamically loaded from a network or an external device that is in communication with the client device.

12. The method of claim 1, wherein the first payload includes software code that has been stored in a local memory of the client device in encrypted form and decrypted by the application program at run time.

13. The method of claim 1, wherein the preventing execution of the first payload when the first payload includes the malicious content includes halting the application program.

14. The method of claim 1, further comprising providing a notification to a user of the client device regarding a result of the determination.

15. The method of claim 1, wherein the first payload is compiled for execution during the determining whether the first payload includes malicious content.

16. An apparatus comprising:
a processing circuit configured to:
obtain a first payload that is dynamically loaded by an application program of the apparatus;
determine whether the first payload includes malicious content;
prevent execution of the first payload when the first payload includes the malicious content; and
execute the first payload when the first payload does not include the malicious content.

17. The apparatus of claim 16, wherein the processing circuit is further configured to:
obtain a function call flow of the application program, the function call flow indicating a second payload that is to be dynamically loaded by the application program;
obtain the second payload before the second payload is dynamically loaded by the application program;
determine whether the second payload includes the malicious content;
prevent dynamic loading of the second payload when the second payload includes the malicious content; and
allow the dynamic loading of the second payload when the second payload does not include the malicious content.

18. The apparatus of claim 16, wherein the processing circuit is further configured to:
analyze the application program to determine a value of a confidence metric;
prevent the application program from dynamically loading a second payload when the value is below a threshold; and
allow the application program to dynamically load the second payload when the value is greater than or equal to the threshold.

19. The apparatus of claim 18, wherein the processing circuit is further configured to:
prevent execution of the second payload when the second payload includes the malicious content; and
execute the second payload when the second payload does not include the malicious content.

20. The apparatus of claim 16, wherein the processing circuit is further configured to:
determine whether the application program at the apparatus includes the malicious content;
determine whether the application program in combination with the first payload includes the malicious content; and
provide a message indicating whether any of the application program, the first payload, and the application program in combination with the first payload includes the malicious content.

21. An apparatus comprising:
means for obtaining a first payload that is dynamically loaded by an application program of the apparatus;
means for determining whether the first payload includes malicious content;
means for preventing execution of the first payload when the first payload includes the malicious content; and
means for executing the first payload when the first payload does not include the malicious content.

22. The apparatus of claim 21, further comprising:
means for obtaining a function call flow of the application program, the function call flow indicating a second payload that is to be dynamically loaded by the application program;
means for obtaining the second payload before the second payload is dynamically loaded by the application program;
means for determining whether the second payload includes the malicious content;
means for preventing dynamic loading of the second payload when the second payload includes the malicious content; and
means for allowing the dynamic loading of the second payload when the second payload does not include the malicious content.

23. The apparatus of claim 21, further comprising:
means for analyzing the application program to determine a value of a confidence metric;
means for preventing the application program from dynamically loading a second payload when the value is below a threshold; and
means for allowing the application program to dynamically load the second payload when the value is greater than or equal to the threshold.

24. The apparatus of claim 23, further comprising:
means for preventing execution of the second payload when the second payload includes the malicious content; and
means for executing the second payload when the second payload does not include the malicious content.

25. The apparatus of claim 21, further comprising:
means for determining whether the application program includes the malicious content;
means for determining whether the application program in combination with the first payload includes the malicious content; and
means for providing a message indicating whether any of the application program, the first payload, and the application program in combination with the first payload includes the malicious content.

26. A non-transitory machine-readable storage medium, the machine-readable storage medium having one or more instructions which when executed by a processing circuit causes the processing circuit to:
obtain a first payload that is dynamically loaded by an application program of a client device;
determine whether the first payload includes malicious content;
prevent execution of the first payload when the first payload includes the malicious content; and
execute the first payload when the first payload does not include the malicious content.

27. The non-transitory machine-readable storage medium of claim 26, wherein the one or more instructions further causes the processing circuit to:
obtain a function call flow of the application program, the function call flow indicating a second payload that is to be dynamically loaded by the application program;
obtain the second payload before the second payload is dynamically loaded by the application program;
determine whether the second payload includes the malicious content;
prevent dynamic loading of the second payload when the second payload includes the malicious content; and
allow the dynamic loading of the second payload when the second payload does not include the malicious content.

28. The non-transitory machine-readable storage medium of claim 26, wherein the one or more instructions further causes the processing circuit to:
analyze the application program to determine a value of a confidence metric;
prevent the application program from dynamically loading a second payload when the value is below a threshold; and
allow the application program to dynamically load the second payload when the value is greater than or equal to the threshold.

29. The non-transitory machine-readable storage medium of claim 28, wherein the one or more instructions further causes the processing circuit to:
prevent execution of the second payload when the second payload includes the malicious content; and
execute the second payload when the second payload does not include the malicious content.

30. The non-transitory machine-readable storage medium of claim 26, wherein the one or more instructions further causes the processing circuit to:
determine whether the application program at the client device includes the malicious content;
determine whether the application program in combination with the first payload includes the malicious content; and
provide a message indicating whether any of the application program, the first payload, and the application program in combination with the first payload includes the malicious content.
